(19) United States
(12) Patent Application Publication
(10) Pub. No.: US 2022/0301031 A1
(43) Pub. Date: Sep. 22, 2022

(54) Machine Learning Based Automated Product Classification

(71) Applicant: Avyay Solutions, Inc., San Jose, CA (US)

(72) Inventor: Dharam Rajen Iyer, Fremont, CA (US)

(21) Appl. No.: 17/700,374

(22) Filed: Mar. 21, 2022

Related U.S. Application Data
(63) Continuation of application No. PCT/US22/21053, filed on Mar. 19, 2022.
(60) Provisional application No. 63/163,275, filed on Mar. 19, 2021.

(51) Int. Cl. G06Q 30/06

(52) U.S. Cl. CPC G06Q 30/0623

(57) ABSTRACT

A system and method for predicting a standardized code classifying a product and automatically executing an actionable item based on the standardized code is disclosed. The method includes receiving a set of data attributes in association with a product, validating the set of data attributes, determining a first machine learning model based on the set of data attributes, determining, using the first machine learning model on the set of data attributes, a first prediction of a standardized code and a first confidence score for the first prediction in association with a classification of the product, determining whether the first confidence score satisfies a threshold, determining an actionable item based on the standardized code in association with the classification of the product responsive to determining that the first confidence score satisfies the threshold, and automatically executing the actionable item.

### CROSS-REFERENCE TO RELATED APPLICATIONS

The present application claims priority, under 35 U.S.C. § 119, of U.S. Provisional Patent Application No. 63/163,275, filed Mar. 19, 2021, and entitled “Automated Product Classification using Machine Learning and Artificial Intelligence,” and is a continuation of PCT Patent Application No. PCT/US22/21053, filed Mar. 19, 2022, and entitled “Machine Learning Based Automated Product Classification,” which are incorporated by reference in their entireties.

### BACKGROUND

This specification generally relates to automating and streamlining the product classification process using machine learning. In particular, the specification relates to a system and method for predicting a standardized code classifying a product and automatically executing an actionable item based on the standardized code.

Within the global trade eco-system, there are millions of products, vendors, and clients involved in trade and shipping activities across complex supply chains and geographies. For example, the import/export activity may include country-specific regulations (depending on prevailing geo-political bilateral relationship between countries) imposed by respective customs authorities. The dynamic nature of the global trade eco-system and ever-increasing number of the entities involved therein makes product classification a crucial task. Moreover, manual classification of products is an exhaustive, erroneous, and expensive task. For example, users may have to spend a large amount of time and effort researching the product in question to determine its classification. Erroneous product classification may lead to compliance and customs management failure by an organization participating in international commerce. As such, there is an increasing demand to minimize human error in the product classification process.

This background description provided herein is for the purpose of generally presenting the context of the disclosure.

### SUMMARY

The techniques introduced herein overcome the deficiencies and limitations of the prior art at least in part by providing systems and methods for predicting a standardized code classifying a product and automatically executing an actionable item based on the standardized code.

According to one innovative aspect of the subject matter described in this disclosure, a method includes: receiving a set of data attributes in association with a product, validating the set of data attributes, determining a first machine learning model based on the set of data attributes, determining, using the first machine learning model on the set of data attributes, a first prediction of a standardized code and a first confidence score for the first prediction in association with a classification of the product, determining whether the first confidence score satisfies a threshold, determining an actionable item based on the standardized code in association with the classification of the product responsive to determining that the first confidence score satisfies the threshold, and automatically executing the actionable item.

According to another innovative aspect of the subject matter described in this disclosure, a system includes: one or more processors; a memory storing instructions, which when executed cause the one or more processors to: receive a set of data attributes in association with a product, validate the set of data attributes, determine a first machine learning model based on the set of data attributes, determine, using the first machine learning model on the set of data attributes, a first prediction of a standardized code and a first confidence score for the first prediction in association with a classification of the product, determine whether the first confidence score satisfies a threshold, determine an actionable item based on the standardized code in association with the classification of the product responsive to determining that the first confidence score satisfies the threshold, and automatically execute the actionable item.

These and other implementations may each optionally include one or more of the following operations. For instance, the operations may include: presenting, for display in a worklist, the first prediction of the standardized code and the first confidence score for the first prediction responsive to determining that the first confidence score fails to satisfy the threshold; receiving, from a user associated with the worklist, feedback in association with the first prediction of the standardized code and the first confidence score for the first prediction; assigning the first prediction of the standardized code to the classification of the product based on the feedback; determining, using the first machine learning model on the set of data attributes, a second prediction of the standardized code and a second confidence score for the second prediction in association with the classification of the product; presenting, for display in a worklist, the first prediction of the standardized code and the first confidence score for the first prediction and the second prediction of the standardized code and the second confidence score for the second prediction; determining a second machine learning model based on the set of data attributes; determining, using the second machine learning model on the set of data attributes, a third prediction of a standardized code and a third confidence score for the third prediction in association with the classification of the product; updating a training dataset based on the feedback; and training the first machine learning model using the updated training dataset. Additionally, these and other implementations may each optionally include one or more of the following features. For instance, the features may include determining the first machine learning model comprising determining a context in association with the set of data attributes, matching the context with a set of metadata associated with the first machine learning model, and selecting the first machine learning model based on the matching; determining the first machine learning model comprising receiving a unique identifier of a machine learning model in association with the set of data attributes, and selecting the first machine learning model from a plurality of machine learning models based on the unique identifier; the set of data attributes in association with the product being a row in a table of products; the set of data attributes in association with the product being received from a group of a business management server, a client device, and an external database; and the actionable item being associated with compliance and customs declarations.

Other implementations of one or more of these aspects and other aspects include corresponding systems, apparatus, and computer programs, configured to perform the various action and/or store various data described in association with these aspects. Numerous additional features may be included in these and various other implementations, as discussed throughout this disclosure.

The features and advantages described herein are not all-inclusive and many additional features and advantages will be apparent in view of the figures and description. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a high-level block diagram illustrating one implementation of an example system for predicting a standardized code classifying a product and automatically executing an actionable item based on the standardized code.

FIG. 2A is a block diagram illustrating one implementation of a computing device including a prediction application.

FIG. 2B is a block diagram illustrating one implementation of a prediction engine.

FIGS. 3A-3D show graphical representations illustrating example predictive frameworks for predicting different types of classification codes.

FIGS. 4A-4B show graphical representations illustrating example predictive frameworks for multiple prediction and multi-model prediction.

FIGS. 5A-5C show graphical representations illustrating example user interfaces for generating a prediction of product classification for a single product.

FIGS. 6A-6C show graphical representations illustrating example user interfaces for generating a prediction of product classification for a batch of products.

FIGS. 7A-7B show graphical representations illustrating example user interfaces for reclassifying old standardized codes of product classification.

FIG. 8 is a flow diagram illustrating one implementation of an example method for predicting a standardized code classifying a product and automatically executing an actionable item based on the standardized code.

### DETAILED DESCRIPTION

The techniques introduced herein overcome the deficiencies and limitations of the prior art, at least in part, with a system and methods for automating and streamlining the product classification process using artificial intelligence (AI) and machine learning (ML). In some implementations, the system and methods of the present disclosure uses AI and ML based approaches to significantly improve and automate product classification and associated processing workflows in international commerce. For a seamless execution of import/export activity, products need to be classified appropriately by assigning standardized codes to each product. For example, in the context of compliance and customs management in global trade service, product classification is incumbent upon an organization to adhere to the regulations imposed by several regulatory agencies and customs authorities. The classification of products using standardized codes is mandatory for international transactions. For example, a harmonized tariff code assigned to product during its classification is used for customs reporting and to determine the duty rates for the product. In another example, export compliance code assigned to a product during its classification is used to check if an export license is required. In the event of erroneous product classification by an organization, it may result in cancellation of import/export license for the organization, imposition of hefty duty/penalties, and even jail term for extreme violation.

In particular, the systems and methods of the present disclosure utilize system-agnostic machine learning to create customized and specific models using artificial intelligence for deploying in an automated process that minimizes human error in product classifications. For example, the machine learning models may be customized to specific rules and regulations, countries, and industries. Product classification using an international classification system, such as harmonized system (HS) is a complicated process. Incorrect product classification is a violation of customs regulations for any country that is party to the harmonized system. For example, tariff classifications are used to determine duty rates for imported goods. If an organization uses the wrong classification, it may result in payment of incorrect duties and improper cost of goods calculation. As classification controls duty rates and revenues, it may be frequently targeted for audit by customs authorities. If customs authorities change tariff classification and determine that rules of origin were not followed properly upon audit, this may result in loss of free trade privileges and penalties. The systems and methods described below for automating and streamlining the product classification process may ensure faster product classification, increased accuracy, data consistency, and mitigate the business risk of compliance errors.

While the present disclosure may describe the techniques herein in the context of an example automated product classification system for facilitating importing and/or exporting goods and products across multi jurisdictional borders, it should be understood that the architecture, principles, and components of the present disclosure may also be used to provide automated services in various other contexts including any areas of global trade, that involve mundane manual tasks, for example, reviewing business partner true match against the denied party list screening, tracing and monitoring errors in the customs filing for export, reviewing of potential errors with import filing, such as duty drawback, preference determination with accurate country of origin and prediction for the right license determination for export and import control. In some implementations, the AI/ML learning of the present disclosure also has application within supply chain, specific areas in the warehouse management for assisting with receiving through warehouse process before final put away and outbound from storage bin through work order request rules. In transportation management, the architecture, principles, and components of the present disclosure may be used for managing the freight cost and transportation, optimized planning, managing actual demand and forecast freight units and orders. In yet other implementations, the architecture, principles, and components of the present disclosure may be used for new product introduction with business planning software. Therefore, the systems and methods described below may be applied to various other areas, processes and transactions in addition to those specifically set forth below.

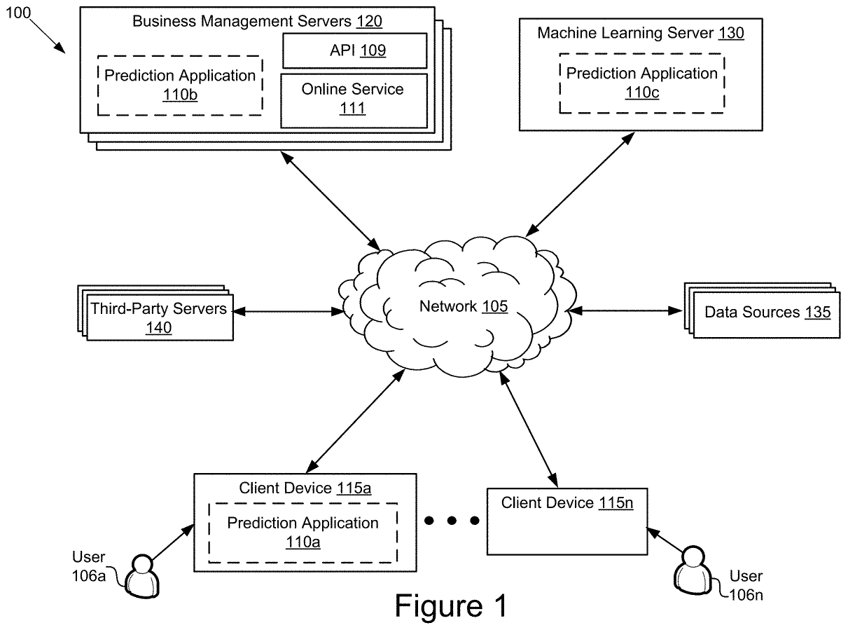

FIG. 1 is a high-level block diagram illustrating one implementation of an example system 100 for predicting a standardized code (e.g., commodity code, tariff code, etc.) classifying a product and automatically executing an actionable item based on the standardized code. The illustrated system 100 may include one or more client devices 115a . . . 115n that can be accessed by users, a plurality of business management servers 120, a machine learning server 130, a plurality of data sources 135, and a plurality of third-party servers 140 which are communicatively coupled via a network 105 for interaction and electronic communication with one another. In FIG. 1 and the remaining figures, a letter after a reference number, e.g., “115a,” represents a reference to the element having that particular reference number. A reference number in the text without a following letter, e.g., “115,” represents a general reference to instances of the element bearing that reference number

The network 105 may be a conventional type, wired or wireless, and may have numerous different configurations including a star configuration, token ring configuration, or other configurations. Furthermore, the network 105 may include any number of networks and/or network types. For example, the network 105 may include a local area network (LAN), a wide area network (WAN) (e.g., the Internet), virtual private networks (VPNs), mobile (cellular) networks, wireless wide area network (WWANs), WiMAX® networks, Bluetooth® communication networks, peer-to-peer networks, near field networks (e.g., NFC, etc.), and/or other interconnected data paths across which multiple devices may communicate, various combinations thereof, etc. The network 105 may also be coupled to or include portions of a telecommunications network for sending data in a variety of different communication protocols. In some implementations, the network 105 may include Bluetooth communication networks or a cellular communications network for sending and receiving data including via short messaging service (SMS), multimedia messaging service (MMS), hypertext transfer protocol (HTTP), direct data connection, WAP, email, etc. In some implementations, the data transmitted by the network 105 may include packetized data (e.g., Internet Protocol (IP) data packets) that is routed to designated computing devices coupled to the network 105. Although FIG. 1 illustrates one network 105 coupled to the client devices 115, the plurality of business management servers 120, the machine learning server 130, the plurality of data sources 135, and the plurality of third-party servers 140, in practice one or more networks 105 may be connected to these entities.

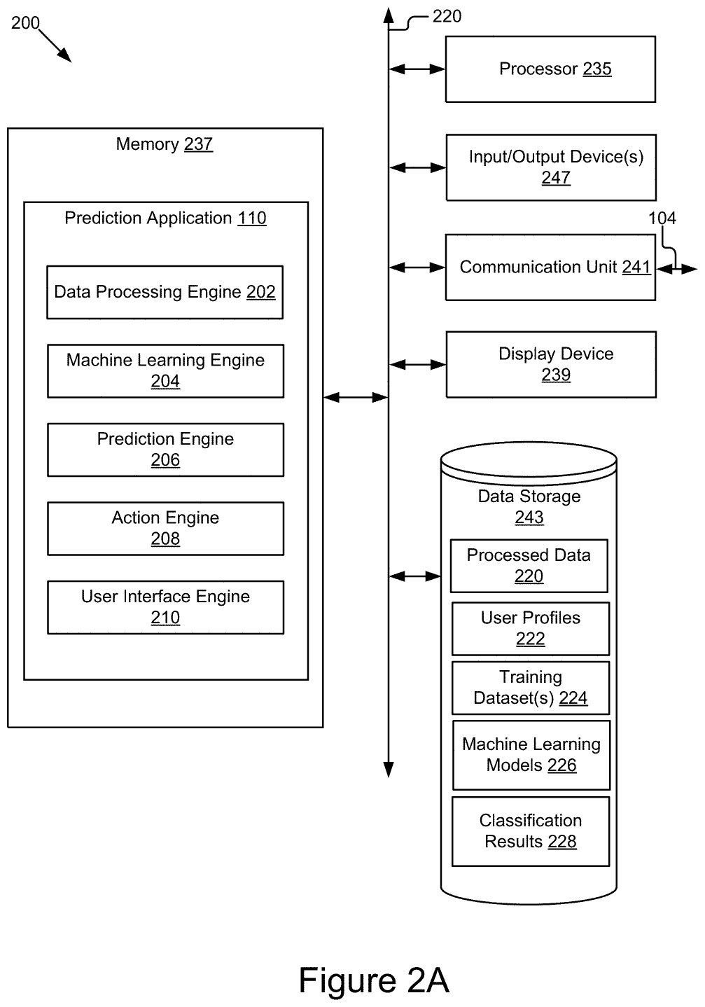

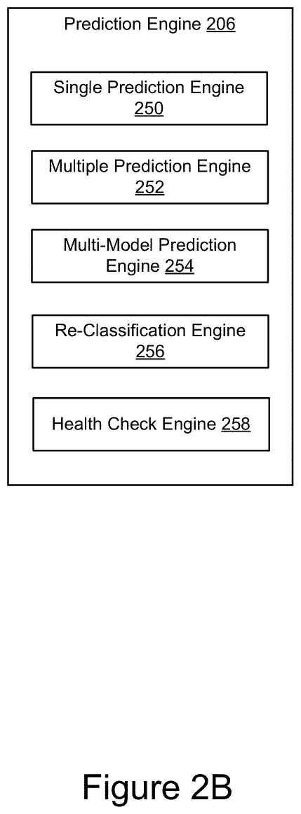

The client devices 115a . . . 115n (also referred to individually and collectively as 115) may be computing devices having data processing and communication capabilities. In some implementations, a client device 115 may include a memory, a processor (e.g., virtual, physical, etc.), a power source, a network interface, software and/or hardware components, such as a display, graphics processing unit (GPU), wireless transceivers, keyboard, camera (e.g., webcam), sensors, firmware, operating systems, web browsers, applications, drivers, and various physical connection interfaces (e.g., USB, HDMI, etc.). The client devices 115a . . . 115n may couple to and communicate with one another and the other entities of the system 100 via the network 105 using a wireless and/or wired connection. Examples of client devices 115 may include, but are not limited to, laptops, desktops, tablets, mobile phones (e.g., smartphones, feature phones, etc.), server appliances, servers, virtual machines, smart TVs, media streaming devices, user wearable computing devices or any other electronic device capable of accessing a network 105. In the example of FIG. 1, the client device 115a is configured to implement a prediction application 110a described in more detail below. The client device 115 includes a display for viewing information provided by one or more entities coupled to the network 105. For example, the client device 115 may be adapted to send and receive data to and from one or more of the business management server 120 and the machine learning server 130. While two or more client devices 115 are depicted in FIG. 1, the system 100 may include any number of client devices 115. In addition, the client devices 115a . . . 115n may be the same or different types of computing devices. The client devices 115a . . . 115n may be associated with the users 106a . . . 106n. For example, users 106a . . . 106n may be authorized personnel including managers, engineers, technicians, administrative staff, etc. of a business organization. Each client device 115 may be associated with a data channel, such as web, mobile, enterprise, and/or cloud applications. For example, the client device 115 may include a web browser to allow authorized personnel to access the functionality provided by other entities of the system 100 coupled to the network 105. In some implementations, the client devices 115 may be implemented as a computing device 200 as will be described below with reference to FIG. 2A.

In the example of FIG. 1, the entities of the system 100, such as the plurality of business management servers 120, the machine learning server 130, the plurality of data sources 135, and the plurality of the third-party servers 140 may be, or may be implemented by, a computing device including a processor, a memory, applications, a database, and network communication capabilities similar to that described below with reference to FIG. 2A. In some implementations, each one of the entities 120, 130, 135, and 140 of the system 100 may be a hardware server, a software server, or a combination of software and hardware. For example, the business management server 120 may include one or more hardware servers, virtual servers, server arrays, storage devices and/or systems, etc., and/or may be centralized or distributed/cloud-based. In some implementations, each one of the entities 120, 130, 135, and 140 of the system 100 may include one or more virtual servers, which operate in a host server environment and access the physical hardware of the host server including, for example, a processor, a memory, applications, a database, storage, network interfaces, etc., via an abstraction layer (e.g., a virtual machine manager). In some implementations, each one of the entities 120, 130, 135, and 140 of the system 100 may be a Hypertext Transfer Protocol (HTTP) server, a Representational State Transfer (REST) service, or other server type, having structure and/or functionality for processing and satisfying content requests and/or receiving content from the other entities 120, 130, 135, and 140 and one or more of the client devices 115 coupled to the network 105.

In the example of FIG. 1, the business management server 120 may be configured to implement a prediction application 110b. Also, instead of or in addition, the business management server 120 may implement its own application programming interface (API) 109 for facilitating access of the business management server 120 by other entities and the transmission of instructions, data, results, and other information between the server 120 and other entities communicatively coupled to the network 105. For example, the API may be a software interface exposed over the HTTP protocol by the business management server 120. The API exposes internal data and functionality of the online service 111 hosted by the business management server 120 to API requests originating from one or more of the prediction application 110, the plurality of data sources 135, the plurality of third-party servers 140, and one or more client devices 115. In some implementations, the business management server 120 may include an online service 111 dedicated to providing access to various services and information resources hosted by the business management server 120 via web, mobile, enterprise, and/or cloud applications. In one example, the online service 11 may be software as a service (SaaS). The online service 111 may offer various services, such as a global trade management service, a trade automation service, a transport management service, supply chain management, enterprise resource planning, etc. For example, in the context of a global trade service, the online service 111 may provide customs and compliance management. It should be noted that the list of services provided as examples for the online service 111 above are not exhaustive and that others are contemplated in the techniques described herein. In some implementations, the business management server 120 may also include a database (not shown) coupled to it (e.g., over the network 105) to store structured data in a relational database and a file system (e.g., HDFS, NFS, etc.) for unstructured or semi-structured data. It should be understood that a single business management server 120 may be representative of an online service provider and there may be multiple online service providers coupled to the network 105, each having its own server or a server cluster, applications, application programming interface, etc.

In the example of FIG. 1, the machine learning server 130 may be configured to implement a prediction application 110c. The machine learning server 130 may be configured to send and receive data and analytics from one or more of the client device 115, the plurality of business management servers 120, the plurality of third-party servers 140, and the plurality of data source 135 via the network 105. For example, the machine learning server 130 receives product attributes and corresponding classifications from the business management server 120. The machine learning server 130 may be configured to curate training datasets and implement machine learning techniques to train and deploy one or more machine learning models based on the training datasets. In some implementations, the machine learning server 130 may also include a database coupled to it (e.g., over the network 105) to store structured data in a relational database and a file system (e.g., HDFS, NFS, etc.) for unstructured or semi-structured data. In some implementations, the machine learning server 130 may include an instance of a data store that stores various types of data for access and/or retrieval by the prediction application 110. For example, the data store may store machine learning models for predicting standardized codes for classifying products. Other types of user data are also possible and contemplated.

In some implementations, the machine learning server 130 may serve as a middle layer and permit interactions between the client device 115 and the plurality of the business management servers 120 and the third-party servers 140 to flow through and from the machine learning server 130 for security and convenience. In some implementations, the machine learning server 120 may be operable to receive new data as input, use one or more trained machine learning models to process the new data, and generate predictions accordingly, etc. It should be understood that the machine learning server 130 is not limited to providing the above-noted acts and/or functionality and may include other network-accessible services. In addition, while a single machine learning server 130 is depicted in FIG. 1A, it should be understood that there may be any number of machine learning servers 130 or a server cluster.

In the example of FIG. 1, the plurality of third-party servers 140 may include servers associated with multiple government customs systems (e.g., United States Customs and Border Protection, United States International Trade Commission, World Customs Organization, Foreign Trade Division of the United States Bureau of the Census, United States Department of Commerce, Directorate of Defense Trade Controls, Automated Export System, Automated Broker Interface, Excise Movement and Control System, Customs Ruling Online Search System, partner government agency, etc.) of national and international countries, regulatory authorities, industry groups, and other content service providers. In some implementations, the business management servers 120 may communicate with the plurality of third-party servers 140. In the context of global trade service, for example, a business management server 120 may cooperate with the plurality of third-party servers 140 for compliance and customs declaration activities to facilitate a seamless execution of import/export activity in global commerce. In some implementations, the machine learning server 130 may communicate with the plurality of third-party servers 140 for identifying one or more revisions or changes within the classification systems (e.g., tariff schedules) and updating the training datasets accordingly.

In the example of FIG. 1, the data sources 135 may be a data warehouse, a system of record (SOR), or belonging to a data repository owned by an organization that provides real-time or close to real-time data automatically or responsive to being polled or queried by the business management server 120 and the machine learning server 130. Each of the plurality of data sources 135 may be associated with a first-party entity (e.g., servers 120, 130) or third-party entity (e.g., server 140 associated with a separate company or service provider), such as a transport and shipping-related call center or customer service company, an inventory management system, global goods service management (GGSM), a global information management system, a public-records database, a blockchain, a data mining platform, news site, forums, blogs, etc. Examples of data provided by the plurality of data sources 135 may relate to creation of products that need classification for international commerce, transport and shipment. In some implementations, each of the plurality of data sources 135 may be configured to provide or facilitate an API (not shown) that allows the prediction application 110 (e.g., prediction application 110b in the business management server 120) to access data and information for performing the functionality described herein.

The prediction application 110 may include software and/or logic to provide the functionality for predicting a standardized code classifying a product and automatically executing an actionable item based on the standardized code. In some implementations, the prediction application 110 may be implemented using programmable or specialized hardware, such as a field-programmable gate array (FPGA) or an application-specific integrated circuit (ASIC). In some implementations, the prediction application 110 may be implemented using a combination of hardware and software. In some implementations, the prediction application 110 may be stored and executed on various combinations of the client device 115, the machine learning server 130, and the business management server 120, or by any one of the client devices 115, the machine learning server 130, or the business management server 120. As depicted in FIG. 1, the prediction application 110a, 110b, and 110c is shown in dotted lines to indicate that the operations performed by the prediction application 110a, 110b, and 110c as described herein may be performed at the client device 115, the business management server 120, the machine learning server 130, or any combinations of these components. In some implementations, each instance 110a, 110b, and 110c may include one or more components of the prediction application 110 depicted in FIG. 2A, and may be configured to fully or partially perform the functionalities described herein depending on where the instance resides.

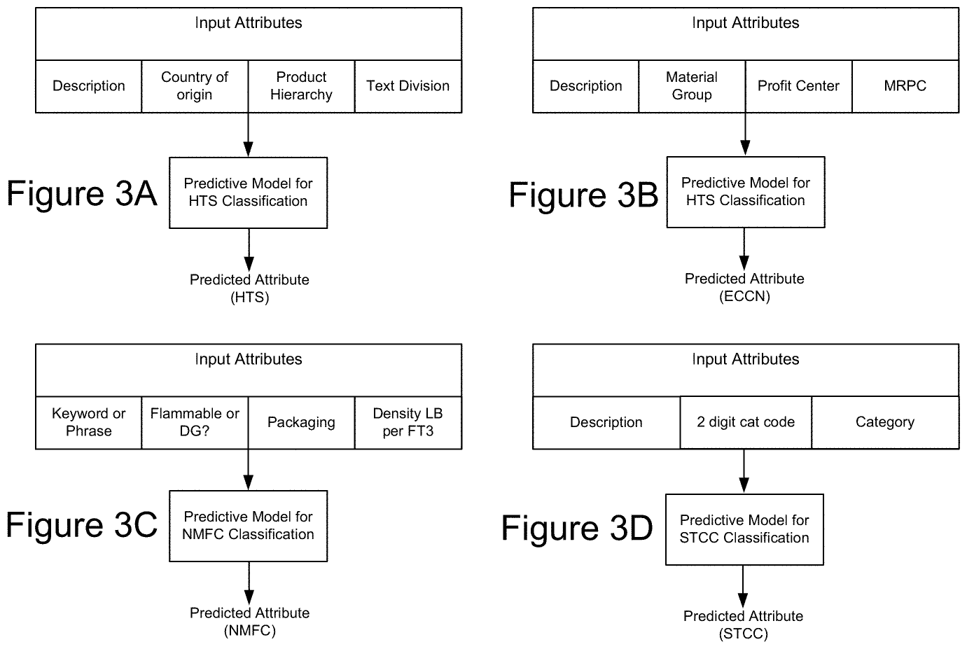

In some implementations, the prediction application 110a may be a thin-client application with some functionality executed on the client device 115 and additional functionality executed on the business management server 120 by the prediction application 110b and on the machine learning server 130 by the prediction application 110c. In some implementations, the prediction application 110 may generate and present various user interfaces to perform these acts and/or functionality, which may in some cases be based at least in part on information received from the business management server 120, the client device 115, the machine learning server 130, one or more of the third-party servers 140 and/or the data sources 135 via the network 105. Non-limiting example user interfaces that may be generated for display by the prediction application 110 are depicted in FIGS. 3A-3D, 4A-4B, 5A-5C, 6A-6C, and 7A-7B. In some implementations, the prediction application 110 is code operable in a web browser, a web application accessible via a web browser, a native application (e.g., mobile application, installed application, etc.) on the client device 115, a plug-in, a combination thereof, etc. Additional structure, acts, and/or functionality of the prediction application 110 is further discussed below with reference to at least FIGS. 2A-2B. While the prediction application 110 is described below as a stand-alone application, in some implementations, the prediction application 110 may be part of other applications in operation on the client device 115, the business management server 120, and the machine learning server 130.

In some implementations, the prediction application 110 may require users to be registered with the business management server 120 to access the acts and/or functionality described herein. For example, to access various acts and/or functionality provided by the prediction application 110, the prediction application 110 may require a user to authenticate his/her identity. For example, the prediction application 110 may require a user seeking access to authenticate their identity by inputting credentials in an associated user interface. In another example, the prediction application 110 may interact with a federated identity server (not shown) to register and/or authenticate the user by scanning and verifying biometrics including username and password, facial attributes, fingerprint, and voice.

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server 120 to a client device 115, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

FIG. 2A is a block diagram illustrating one implementation of a computing device 200 including a prediction application 110. The computing device 200 may also include a processor 235, a memory 237, a display device 239, a communication unit 241, an input/output device(s) 247, and a data storage 243, according to some examples. The components of the computing device 200 are communicatively coupled by a bus 220. In some implementations, the computing device 200 may be representative of the client device 115, the business management server 120, the machine learning server 130, or a combination of the client device 115, the business management server 120, and the machine learning server 130. In such implementations where the computing device 200 is the client device 115, the business management server 120 or the machine learning server 130, it should be understood that the client device 115, the business management server 120, and the machine learning server 130 may take other forms and include additional or fewer components without departing from the scope of the present disclosure. For example, while not shown, the computing device 200 may include sensors, capture devices, additional processors, and other physical configurations. Additionally, it should be understood that the computer architecture depicted in FIG. 2A could be applied to other entities of the system 100 with various modifications, including, for example, the servers 140 and data sources 135.

The processor 235 may execute software instructions by performing various input/output, logical, and/or mathematical operations. The processor 235 may have various computing architectures to process data signals including, for example, a complex instruction set computer (CISC) architecture, a reduced instruction set computer (RISC) architecture, and/or an architecture implementing a combination of instruction sets. The processor 235 may be physical and/or virtual, and may include a single processing unit or a plurality of processing units and/or cores. In some implementations, the processor 235 may be capable of generating and providing electronic display signals to a display device 239, supporting the display of images, capturing and transmitting images, and performing complex tasks including various types of feature extraction and sampling. In some implementations, the processor 235 may be coupled to the memory 237 via the bus 220 to access data and instructions therefrom and store data therein. The bus 220 may couple the processor 235 to the other components of the computing device 200 including, for example, the memory 237, the communication unit 241, the display device 239, the input/output device(s) 247, and the data storage 243.

The memory 237 may store and provide access to data for the other components of the computing device 200. The memory 237 may be included in a single computing device or distributed among a plurality of computing devices as discussed elsewhere herein. In some implementations, the memory 237 may store instructions and/or data that may be executed by the processor 235. The instructions and/or data may include code for performing the techniques described herein. For example, as depicted in FIG. 2A, the memory 237 may store the prediction application 110. The memory 237 is also capable of storing other instructions and data, including, for example, an operating system, hardware drivers, other software applications, databases, etc. The memory 237 may be coupled to the bus 220 for communication with the processor 235 and the other components of the computing device 200.

The memory 237 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 235. In some implementations, the memory 237 may include one or more of volatile memory and non-volatile memory. It should be understood that the memory 237 may be a single device or may include multiple types of devices and configurations.

The bus 220 may represent one or more buses including an industry standard architecture (ISA) bus, a peripheral component interconnect (PCI) bus, a universal serial bus (USB), or some other bus providing similar functionality. The bus 220 may include a communication bus for transferring data between components of the computing device 200 or between computing device 200 and other components of the system 100 via the network 105 or portions thereof, a processor mesh, a combination thereof, etc. In some implementations, the prediction application 110 and various other software operating on the computing device 200 (e.g., an operating system, device drivers, etc.) may cooperate and communicate via a software communication mechanism implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication may be configured to be secure (e.g., SSH, HTTPS, etc.).

The display device 239 may be any conventional display device, monitor or screen, including but not limited to, a liquid crystal display (LCD), light emitting diode (LED), organic light-emitting diode (OLED) display or any other similarly equipped display device, screen or monitor. The display device 239 represents any device equipped to display user interfaces, electronic images, and data as described herein. In some implementations, the display device 239 may output display in binary (only two different values for pixels), monochrome (multiple shades of one color), or multiple colors and shades. The display device 239 is coupled to the bus 220 for communication with the processor 235 and the other components of the computing device 200. In some implementations, the display device 239 may be a touch-screen display device capable of receiving input from one or more fingers of a user. For example, the display device 239 may be a capacitive touch-screen display device capable of detecting and interpreting multiple points of contact with the display surface. In some implementations, the computing device 200 (e.g., client device 115) may include a graphics adapter (not shown) for rendering and outputting the images and data for presentation on display device 239. The graphics adapter (not shown) may be a separate processing device including a separate processor and memory (not shown) or may be integrated with the processor 235 and memory 237.

The input/output (I/O) device(s) 247 may include any standard device for inputting or outputting information and may be coupled to the computing device 200 either directly or through intervening I/O controllers. In some implementations, the input device 247 may include one or more peripheral devices. Non-limiting example I/O devices 247 include a touch screen or any other similarly equipped display device equipped to display user interfaces, electronic images, and data as described herein, a touchpad, a keyboard, a scanner, a stylus, an audio reproduction device (e.g., speaker), a microphone array, a barcode reader, an eye gaze tracker, a sip-and-puff device, and any other I/O components for facilitating communication and/or interaction with users. In some implementations, the functionality of the input/output device 247 and the display device 239 may be integrated, and a user of the computing device 200 (e.g., client device 115) may interact with the computing device 200 by contacting a surface of the display device 239 using one or more fingers. For example, the user may interact with an emulated (i.e., virtual or soft) keyboard displayed on the touch-screen display device 239 by using fingers to contact the display in the keyboard regions.

The communication unit 241 is hardware for receiving and transmitting data by linking the processor 235 to the network 105 and other processing systems via signal line 104. The communication unit 241 may receive data such as requests from the client device 115 and transmit the requests to the prediction application 110, for example a request to predict standardized code for classifying a product based on its attributes. The communication unit 241 also transmits information including media to the client device 115 for display, for example, in response to the request. The communication unit 241 is coupled to the bus 220. In some implementations, the communication unit 241 may include a port for direct physical connection to the client device 115 or to another communication channel. For example, the communication unit 241 may include an RJ45 port or similar port for wired communication with the client device 115. In other implementations, the communication unit 241 may include a wireless transceiver (not shown) for exchanging data with the client device 115 or any other communication channel using one or more wireless communication methods, such as IEEE 802.11, IEEE 802.16, Bluetooth® or another suitable wireless communication method.

In yet other implementations, the communication unit 241 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still other implementations, the communication unit 241 may include a wired port and a wireless transceiver. The communication unit 241 also provides other conventional connections to the network 105 for distribution of files and/or media objects using standard network protocols such as TCP/IP, HTTP, HTTPS, and SMTP as will be understood to those skilled in the art.

The data storage 243 is a non-transitory memory that stores data for providing the functionality described herein. In some implementations, the data storage 243 may be coupled to the components 235, 237, 239, 241, and 247 via the bus 220 to receive and provide access to data. In some implementations, the data storage 243 may store data received from other elements of the system 100 including, for example, entities 120, 130, 135, 140, and/or the prediction applications 110, and may provide data access to these entities. The data storage 243 may store, among other data, processed data 220, user profiles 222, training datasets 224, machine learning models 226, and classification results 228. The data storage 243 stores data associated with predicting a standardized code classifying a product and automatically executing an actionable item based on the standardized code and other functionality as described herein. The data stored in the data storage 243 is described below in more detail.

The data storage 243 may be included in the computing device 200 or in another computing device and/or storage system distinct from but coupled to or accessible by the computing device 200. The data storage 243 may include one or more non-transitory computer-readable mediums for storing the data. In some implementations, the data storage 243 may be incorporated with the memory 237 or may be distinct therefrom. The data storage 243 may be a dynamic random-access memory (DRAM) device, a static random-access memory (SRAM) device, flash memory, or some other memory devices. In some implementations, the data storage 243 may include a database management system (DBMS) operable on the computing device 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. In other implementations, the data storage 243 also may include a non-volatile memory or similar permanent storage device and media including a hard disk drive, a CD-ROM device, a DVD-ROM device, a DVD-RAM device, a DVD-RW device, a flash memory device, or some other mass storage device for storing information on a more permanent basis.

It should be understood that other processors, operating systems, sensors, displays, and physical configurations are possible.

As depicted in FIG. 2A, the memory 237 may include the prediction application 110. In some implementations, the prediction application 110 may be configured to implement a secure HTTP API (not shown) to facilitate web, mobile, enterprise, and/or cloud applications to predict a standardized code classifying a product based on a set of data attributes and automatically execute an actionable item based on the standardized code.

In some implementations, the prediction application 110 may include a data processing engine 202, a machine learning engine 204, a prediction engine 206, an action engine 208, and a user interface engine 210. The components 202, 204, 206, 208, and 210 may be communicatively coupled by the bus 220 and/or the processor 235 to one another and/or the other components 237, 239, 241, 243, and 247 of the computing device 200 for cooperation and communication. The components 202, 204, 206, 208, and 210 may each include software and/or logic to provide their respective functionality. In some implementations, the components 202, 204, 206, 208, and 210 may each be implemented using programmable or specialized hardware including a field-programmable gate array (FPGA) or an application-specific integrated circuit (ASIC). In some implementations, the components 202, 204, 206, 208, and 210 may each be implemented using a combination of hardware and software executable by the processor 235. In some implementations, each one of the components 202, 204, 206, 208, and 210 may be sets of instructions stored in the memory 237 and configured to be accessible and executable by the processor 235 to provide their acts and/or functionality. In some implementations, the components 202, 204, 206, 208, and 210 may send and receive data, via the communication unit 241, to and from one or more of the client devices 115, the business management server 120, the machine learning server 130, the data sources 135, and third-party servers 140.

The data processing engine 202 may include software and/or logic to provide functionality for receiving, processing, and storing a stream of data received from one or more entities of the system 100. The stream of data may correspond to numerous international trade processes, such as enterprise-level global trade service and transport management systems. For example, the stream of data may correspond to a plurality of products, product attributes, and corresponding product classifications of standardized codes from the plurality of business management servers 120, the third-party servers, the data sources 135, and the client devices 115. In some implementations, the data processing engine 202 instantiates a data ingestion layer that transports data from one or more entities of the system 100 to the data storage 243 where it can be stored, accessed, and analyzed. For example, the data ingestion layer processes incoming data, prioritizes sources, validates individual files, and routes the data to the data storage 243. In some implementations, the data processing engine 202 instantiates a data transformation layer that maps and transforms data received from a source. For example, the data transformation layer transforms non-XML data format (e.g., of a data source 135) to XML data format for storage. In some implementations, the data processing engine 202 processes, correlates, integrates, and synchronizes the received data streams from disparate devices 115, servers 120, 140, and data sources 135 into a consolidated data stream to perform the functionalities as described herein.

The data processing engine 202 may preserve privacy by identifying and isolating personal identifiable information (PII) from the received data stream before further processing is performed on the data. For example, the data processing engine 202 filters the PII data from the non-personal data in the received data stream. In some implementations, the data processing engine 202 anonymizes the personal identifiable information (PII) in the received data stream to preserve privacy. The data processing engine 202 may implement several stages of data processing including data cleaning, feature extraction, feature selection, etc. For example, the data processing engine 202 may perform data cleaning to remove bias and critical errors through data analysis before the data is forwarded to the machine learning pipeline for training machine learning models. In some implementations, the data processing engine 202 analyzes the received data to identify metadata. For example, the metadata may include, but is not limited to, name of the feature or column, a type of the feature (e.g., text, integer, etc.), whether the feature is categorical (e.g., product type, manufacturer, seller, etc.), etc. The data processing engine 202 performs feature selection to identify a set of features to train machine learning models based on the metadata. For example, the data processing engine 202 performs feature selection using one or more supervised feature selection techniques. In some implementations, the data processing engine 202 scans the received data and automatically infers the data types of the columns based on rules and/or heuristics and/or dynamically using machine learning. For example, the data processing engine 202 may identify categorical and text data types in the received data to be important contributors to the model training and select those columns.

In some implementations, the data processing engine 202 may use one or more machine learning models to analyze the received data for gleaning valuable insights and identifying issues, such as curse of dimensionality, impurity of data points, errors, outliers, etc. The data processing engine 202 may customize and create these machine learning models with the help of machine learning engine 204 to improve data processing and data quality. In some implementations, the data processing engine 202 may support decentralized data processing. For example, the data processing engine 202 instance in the prediction application 110 on the client device 115 and the business management server 120 may detect the errors and impurity of data points at its source, clean, and send the cleaned data to the data processing engine 202 instance in the prediction application 110c on the machine learning server 130. In some implementations, the data processing engine 202 instructs the user interface engine 210 to generate a user interface to facilitate the several stages of data processing and receive user feedback relating to the data processing results. For example, the user interface may enable a user to visualize the data and select one or more machine learning models to process the data. The user feedback may be recursive to one or more machine learning models to improve the data processing. Some examples of data processing to clean the received data may include, but are not limited to, parsing, handling missing data, removing duplicate or irrelevant observations, fixing structural errors, normalization, transformation, auto tagging, null value treatment, leading zero treatment, etc. In some implementations, the data processing engine 202 is coupled to the data storage 243 to store the processed data 220 in the data storage 243.

The machine learning engine 204 may include software and/or logic to provide functionality for generating model training datasets 224 and training one or more machine learning models 226 using the training datasets 224. In some implementations, the machine learning engine 204 curates one or more training datasets 224 based on the data received and processed in association with one or more of the client devices 115, the business management servers 120, the machine learning server 130, the third-party servers 140, and the data sources 135. For example, the machine learning engine 204 may receive the historical product classification data under different classification schemes for generating the training datasets 224. Example training datasets 224 curated by the machine learning engine 204 may include, but not limited to, a dataset of product attributes and a labelled harmonized tariff schedule (HTS) code as the standardized code to predict for product attributes, a dataset of product attributes and a labelled export control classification number (ECCN) code as the standardized code to predict for product attributes, a dataset of product attributes and a labelled schedule B code as the standardized code to predict for product attributes, a dataset of product attributes and a labelled national motor freight classification (NMFC) code as the standardized code to predict for product attributes, a dataset of product attributes and a labelled standard transportation commodity code (STCC) as the standardized code to predict for product attributes, a dataset of commerce control list (CCL), a dataset of harmonized tariff schedule, a dataset of standardized codes and actionable items for the standardized codes, a dataset of product attributes and export license paperwork to predict, a dataset of product attributes and duty rates to predict, a dataset of standardized code identification hints and patterns, a dataset of sanctioned party list, a dataset of trade embargoes, etc.

In some implementations, the machine learning engine 204 may create a crowdsourced training dataset 224. For example, in the instance where an organization (e.g., a global trade management company) consents to use of their data for creating a training dataset, the machine learning engine 204 forwards the aggregated data to remotely located subject matter expert reviewers to review the data, identify a segment of the data, classify and provide or identify a label for the identified data segment. In some implementations, the machine learning engine 204 includes or excludes data in the training dataset based on business input, biases, and boundary conditions of the data. The machine learning engine 204 stores the curated training datasets 224 in the data storage 243. The machine learning engine 204 uses the training datasets 224 to train the machine learning models for performing the various functionalities as described herein.

In some implementations, the machine learning engine 204 creates one or more machine learning models 226 for the prediction engine 206 (described in detail below) to score standardized code predictions for a product. For example, the machine learning model 226 may be a trained model specific to the USA that is able classify input product attributes, such as product description, material group, profit center, transaction code, etc. and predict ECCN codes for the products before exporting. In some implementations, the machine learning engine 204 may include a one-step process to train, tune, and test machine learning models 226. The machine learning engine 204 automatically and simultaneously selects between distinct machine learning algorithms and determines optimal model parameters for building machine learning models 226. The machine learning engine 204 may measure the model performance during testing and optimize the model 226 using one or more measures of fitness. The fitness measures used may vary based on the specific objective of the model 226. Example of potential measures of fitness include, but are not limited to, accuracy, precision, recall, area under curve (AUC), Gini coefficient, F1 score, confusion matrix, etc.

The machine learning engine 204 facilitates with providing input necessary to create a particular machine learning model 226. In some implementations, the machine learning engine 204 receives and/or generates data, models, training data, and scoring parameters necessary to create the machine learning model 226. For example, the machine learning engine 204 may provide curated text or categorical inputs, provide hints and patterns associated with standardized code prediction, provide model negators, perform training, testing, approve, and publish model versions for consumption, perform scoring model parameter tuning, or create scoring accuracy thresholds for generating a model 226. The machine learning engine 204 is adapted to receive input from users, such as data scientists, analysts, or engineering staff to define and enhance the machine learning models 226. The machine learning engine 204 may provide a secure portal through which these users may define, train, test, publish, refine, and improve the machine learning models 226 or introduce new models. For example, the portal may be used to define, train, test and publish models 226 for prediction of standardized codes in a particular industry group, such as household and personal products. The portal allows the users to provide training data—text inputs, synonyms, conjugation, typos, mispronunciations, model negators, etc. The portal enables the users to define and modify scoring thresholds for training and testing models 226. The portal allows users to enhance the models during training using machine learning hints, patterns, and/or user feedback. The portal further enables the users to control or reduce the overlap of inputs between classes (i.e., standardized codes) during the training of a machine learning model 226.

In some implementations, the machine learning engine 204 emphasizes certain sets of features, traits or attributes in a machine learning model 226 during training for improving recognition, accuracy, computational speed, etc. For example, a predictive model for HTS code product classification may be trained based on the following features or attributes, including but not limited to: product description, country of origin, product hierarchy, text division, etc. In some implementations, the machine learning engine 204 augments or enhances the model with a knowledge base that includes commerce control list, index search terms input in customs rulings online search system (CROSS) database and associated rulings obtained for those terms. The knowledge base may also be enhanced to include subject matter expert inputs, such as explanatory notes to the harmonized tariff schedule.

The machine learning engine 204 may facilitate with developing and providing an actionable item in association with a prediction of a standardized code for product classification. For example, the actionable item may be presented as a recommendation during an import/export workflow in global trade service. In some implementations, the machine learning engine 204 may provide a portal for users with domain knowledge and subject matter expertise to define, refine, author, optimize, and promote one or more actionable items for each prediction of standardized code. For example, the portal may be used for authoring, approving, and publishing of actionable items; enable profile-based filtering of actionable items; configure thresholds for surfacing the actionable items in the worklist, etc. The machine learning engine 204 may create one or more machine learning models for the action engine 208 (described in detail below) to identify and recommend actionable items in association with predicted product classifications. For example, the machine learning engine 204 may train one or more machine learning models 226 using features, such as the standardized code, classification score for the standardized code, the set of product attributes and contextual data, and user profile data to output an appropriate actionable item from a pool of promoted or approved actionable items. The machine learning engine 204 provides the actionable items to the data storage 243 for storage. In some implementations, the actionable items may be stored as part of the machine learning models 226 in the data storage 243.

In some implementations, the machine learning engine 204 may be configured to incrementally adapt and train the one or more machine learning models 226 every threshold period of time. For example, the machine learning engine 204 may incrementally train the machine learning models 226 every hour, every day, every week, every month, etc. based on the aggregated dataset. In some implementations, a machine learning model 226 is a neural network model and includes a layer and/or layers of memory units where memory units each have corresponding weights. A variety of neural network models may be utilized including feed forward neural networks, convolutional neural networks, recurrent neural networks, radial basis functions, other neural network models, as well as combinations of several neural networks. Additionally, or alternatively, the machine learning model 226 may represent a variety of other machine learning techniques in addition to neural networks, for example, support vector machines, decision trees, Bayesian networks, random decision forests, k-nearest neighbors, linear regression, least squares, hidden Markov models, other machine learning techniques, and/or combinations of machine learning techniques.

In some implementations, the machine learning engine 204 may train one or more machine learning models 226 to perform a single machine learning task or a variety of machine learning tasks. In other implementations, the machine learning engine 204 may train a machine learning model 226 to perform multiple tasks. In yet other implementations, the machine learning engine 204 may train a machine learning model 226 to receive the requested data and generate the response data.

The machine learning engine 204 determines a plurality of training instances or samples from the training dataset 224. The machine learning engine 204 may apply a training instance as input to a machine learning model 226. In some implementations, the machine learning engine 204 may train the machine learning model 226 using any one of at least one of supervised learning (e.g., support vector machines, neural networks, logistic regression, linear regression, stacking, gradient boosting, etc.), unsupervised learning (e.g., clustering, neural networks, singular value decomposition, principal component analysis, etc.), or semi-supervised learning (e.g., generative models, transductive support vector machines, etc.). Additionally, or alternatively, machine learning models 226 in accordance with some implementations may be deep learning networks including recurrent neural networks, convolutional neural networks (CNN), networks that are a combination of multiple networks, etc. The machine learning engine 204 may generate a predicted machine learning model output by applying training input to the machine learning model 226. Additionally, or alternatively, the machine learning engine 204 may compare the predicted machine learning model output with a known labelled output from the training instance and, using the comparison, update one or more weights in the machine learning model 226. In some implementations, the machine learning engine 204 may update the one or more weights by backpropagating the difference over the entire machine learning model 226.

In some implementations, the machine learning engine 204 may test a trained machine learning model 226 and update it accordingly. The machine learning engine 204 may partition the training dataset 224 into a testing dataset and a training dataset. The machine learning engine 204 may apply a testing instance from the training dataset 224 as input to the trained machine learning model 226. A predicted output generated by applying a testing instance to the trained machine learning model 226 may be compared with a known output for the testing instance to update an accuracy value (e.g., an accuracy percentage) for the machine learning model 226. For example, the machine learning engine 204 analyzes the accuracy scores of classifying various classes (i.e., standardized codes) by a country-specific predictive model for product classification. In some implementations, the machine learning engine 204 may version and service the model 226 through an internal HTTP endpoint to be used by other component(s) of the prediction application 110. For example, once a model 226 is trained and tested and determined to have acceptable accuracy (e.g., accuracy score satisfying a threshold), the machine learning engine 204 pushes the model 226 to the prediction engine 206 to consume for scoring standardized codes for new products. In some implementations, model development is an iterative process with retraining, testing and publishing steps performed iteratively, and adapted automatically to improve scores and accuracy. New versions will be published based on improvements and retraining using historical data, feedback, and efficiency calculations as more data is collected over a period of time. For example, a model's predicted class labels (standardized codes of a particular classification system) may require business oversight and will be promoted for usage by capability based on business review. Continuous retraining using training data are performed based on curation as part of data analysis.

In some implementations, the machine learning engine 204 implements federated learning to train the machine learning models 226. For example, the machine learning engine 204 instance in the prediction application 110 on the client device 115 and the business management server 120 may train the models 226 privately and locally in a decentralized fashion. The machine learning engine 204 instance in the prediction application 110 on the machine learning server 130 may then receive and aggregate the updates (e.g., transferred model knowledge) after the models are privately and locally trained on the device 115 and the server 120. The machine learning engine 204 instance in the prediction application 110 on the machine learning server 130 facilitates model enhancement by ensembling of the weights from the decentralized models trained on the device 115 and the server 120.

In some implementations, the machine learning engine 204 generates a variety of metadata to associate with the models 226. For example, the metadata may include, but are not limited to a unique identifier, a model name, a model description, a model version, a model type, a date of model creation, status (active or retired), and other training metadata and parameters. The machine learning engine 204 stores the trained machine learning models 226 and corresponding metadata in the data storage 243.

The prediction engine 206 may include software and/or logic to provide functionality for determining a prediction of a standardized code in association with a classification of a product. In one example, the prediction of the standardized code is used to appropriately identify a classification of the product to support global trade functions and ensure compliance with customs procedures. The prediction engine 206 may receive a set of product data attributes as input associated with a business workflow. For example, the set of product attributes may include platform, family, portfolio, performance, plan, trade, specification, CAS Number, safety data sheet, market code name, trademark, vertical segment, etc. The business workflow may include an organization or entity engaged in international product transaction (e.g., import, export, etc.) in the context of global trade. The input may be pushed to the prediction engine 206 from one or more entities of the system 100, such as the business management server 120, the client device 115, and the data sources 135. In one example, the prediction engine 206 may receive the set of product attributes in the form of extensible markup language (XML) format (e.g., XML document, XML string, etc.) from the business management server 120. In another example, the prediction engine 206 may receive the set of product data attributes in the form of structured data (e.g., comma-separated values (CSV) file, Microsoft® Excel file, etc.) uploaded from a web browser on the client device 115. In yet another example, the prediction engine 206 may receive the set of product data attributes (e.g., JavaScript Object Notation (JSON) file) from the data sources 135 via a database connection. The prediction engine 206 is coupled to receive one or more operational machine learning models 226 deployed by the machine learning engine 204. The prediction engine 206 processes the input through one or more machine learning models 226 and generates response data including a prediction of a standardized code (e.g., HTS, ECCN, etc.) associated with the classification of the product and a confidence score for the prediction.

In some implementations, the prediction engine 206 loads the response data into a worklist associated with a user. For example, the worklist may include an overview of products involved in a global trade process and the prediction engine 206 may assign the predicted standardized code for a corresponding product in the worklist. The prediction engine 206 may populate the worklist based on the creation of new products in the import/export workflow of an organization. For example, the new products may match a saved preset of product categories to review in a profile of the user associated with the worklist. When the prediction engine 206 assigns a prediction of the standardized code for a product in the worklist, the user may accept or modify the prediction in the worklist. Once accepted, the standardized code classifying the product is updated in the product master data that is created centrally and valid for one or more connected applications in the business workflow. If the prediction is modified or rejected by the user, the prediction engine 206 may forward the feedback to the machine learning engine 204 for retraining the machine learning model 226 deployed for the prediction. In some implementations, the prediction engine 206 may determine whether the confidence score associated with the prediction of the standardized code satisfies a predetermined threshold and automatically assign the prediction of the standardized code for the product in the worklist without user input responsive to determining that the confidence score satisfies the predetermined threshold. For example, the predetermined threshold may be 90%. The prediction engine 206 may create a user profile 222 for a user of the worklist. The user profile 222 may include data and insights about the user including name, unique user identifier, location, profile photo, job title, worklist, history, user preferences (e.g., preferred machine learning model for product classification, primary job responsibility, etc.), etc. The prediction engine 206 stores and updates the user profiles 222 in the data storage 243.

In some implementations, the prediction engine 206 may synchronize multiple machine learning models 226 in a single layer or multilayer pipeline for processing a set of data attributes of a product and returning a classification prediction. The prediction engine 206 validates the set of data attributes provided as input. For example, the prediction engine 206 checks the set of data attributes for possible errors or discrepancy before processing and responds to the source that made the prediction request with an error notification if there is an error or discrepancy. In some implementations, the prediction engine 206 preprocess the input set of data attributes such that a relevant set of data attributes are processed for determining the end prediction. For example, the prediction engine 206 may replace a data attribute in the input set with an updated data attribute, drop a data attribute entirely from the input set, merge two or more data attributes into a new data attribute, etc.

In some implementations, the prediction engine 206 determines the machine learning model 226 to use for the prediction based on the set of data attributes for the product and contextual metadata associated with the request for prediction. For example, the machine learning model 226 may be trained and deployed for scoring predictions specific to a geographical location (e.g., country, region, etc.), an industry group, or a particular set of customs regulations (e.g., export, import, duty drawback, etc.). The prediction engine 206 matches the set of data attributes of the product and the contextual metadata associated with the request for prediction against the metadata of the models 226 to select the right one. For example, a product that is being imported into the USA may have its set of product attributes fed to a model that is specific to the USA for product classification. In some implementations, the prediction engine 206 receives a unique identifier of a model 226 associated with the request for prediction. For example, the request for prediction includes the unique identifier of the model and the input set of product attributes. The prediction engine 206 retrieves and loads the corresponding model matching the unique identifier for scoring predictions. The prediction engine 206 stores the product classification results 228 in the data storage 243.

FIGS. 3A-3D show graphical representations illustrating example predictive frameworks for predicting different types of classification codes. FIG. 3A depicts an example predictive framework for predicting a target harmonized tariff schedule (HTS) code in the context of global trade service. For example, a set of data attributes of a product, such as product description, country of origin, product hierarchy, and text division may be identified as input attributes to use for prediction. The prediction engine 206 forwards the input attributes to the predictive model for HTS code classification to predict the target HTS code including a confidence score corresponding to the product. FIG. 3B depicts an example predictive framework for predicting a target export control classification number (ECCN) code in the context of global trade service. For example, a set of data attributes of a product, such as product description, material group, profit center, and material requirement planning code (MRPC) may be identified as input attributes to use for prediction. The prediction engine 206 forwards the input attributes to the predictive model for ECCN code classification to predict the target ECCN code including a confidence score corresponding to the product. FIG. 3C depicts an example predictive framework for predicting a national motor freight classification (NMFC) code in the context of transport management. For example, a set of data attributes of a product, such as keyword or phrase, a confirmation of whether it is flammable or dangerous goods, packaging type, and density (e.g., pounds per cubic foot) may be identified as input attributes to use for prediction. The prediction engine 206 forwards the input attributes to the predictive model for NMFC code classification to predict the target NMFC code including a confidence score corresponding to the product. FIG. 3D depicts an example predictive framework for predicting a standard transportation commodity code (STCC) in the context of transport management. For example, a set of data attributes of a product, such as description, a 2 digit cat code, and category may be identified as input attributes to use for prediction. The prediction engine 206 forwards the input attributes to the predictive model for STCC classification to predict the target STCC number including a confidence score corresponding to the product.

A representation of the example input data frame of product information is shown in Table I below. The example input data frame includes product attributes, such as material type, material group, product hierarchy, and product description. Each row in Table I corresponds to a set of product data attributes.

TABLE I
132 Sample Input Data

| Material | Material | Product | |
|---|---|---|---|
| Type | Group | Hierarchy | Description |
| FERT | XYZ | AV11AV11AV11AV1 | White Porcelain Coffee Mug |
| FERT | HIJ | AV11AV11AV11AV2 | Black Certified Organic Tea |
| | | | Bags 2 Kgs |
| FERT | KLM | AV11AV11AV11AV3 | Magnetic Drive Pump Unit |

A representation of the example output prediction data frame obtained as a result of processing by a machine learning model is shown in Table II below. Table II includes additional columns associated with prediction and confidence score for each set of product data attributes.

TABLE II
133 Sample Output Data

| Material | Material | Product | | | Confidence |
|---|---|---|---|---|---|
| Type | Group | Hierarchy | Description | Prediction | (%) |
| FERT | XYZ | AV11AV11AV11AV1 | White Porcelain Coffee Mug | 6911104500 | 85 |
| FERT | HIJ | AV11AV11AV11AV2 | Black Certified Organic | 0902300015 | 90 |
| | | | Tea Bags 2 Kgs | | |
| FERT | KLM | AV11AV11AV11AV3 | Magnetic Drive Pump unit | 8413702090 | 78 |

FIG. 2B is a block diagram illustrating an example implementation of the prediction engine 206. As depicted, the prediction engine 206 may include a single prediction engine 250, a multiple prediction engine 252, a multi-model prediction engine 254, a re-classification engine 256, and a health check engine 258, although it should be understood that the prediction engine 206 may include additional components. The components 250, 252, 254, 256, and 258 may be configured to implement a machine learning-based scoring pipeline to execute their functionality as described herein. The components 250, 252, 254, 256, and 258 may be configured to execute in parallel or in sequence. Each one of the components 250, 252, 254, 256, and 258 may be configured to transmit their generated results or output scores to the other components of the prediction application 110 for performing the functionality as described herein. The prediction engine 206 may use machine learning-based scoring pipeline to arrive at the highest likelihood of a standardized code matching the product attributes.

The single prediction engine 250 analyzes an input set of data attributes for a product using a machine learning model 226 and generates a prediction of a standardized code and a confidence score for the prediction. For example, the prediction of the standardized code may be a single best prediction satisfying a predetermined confidence threshold.

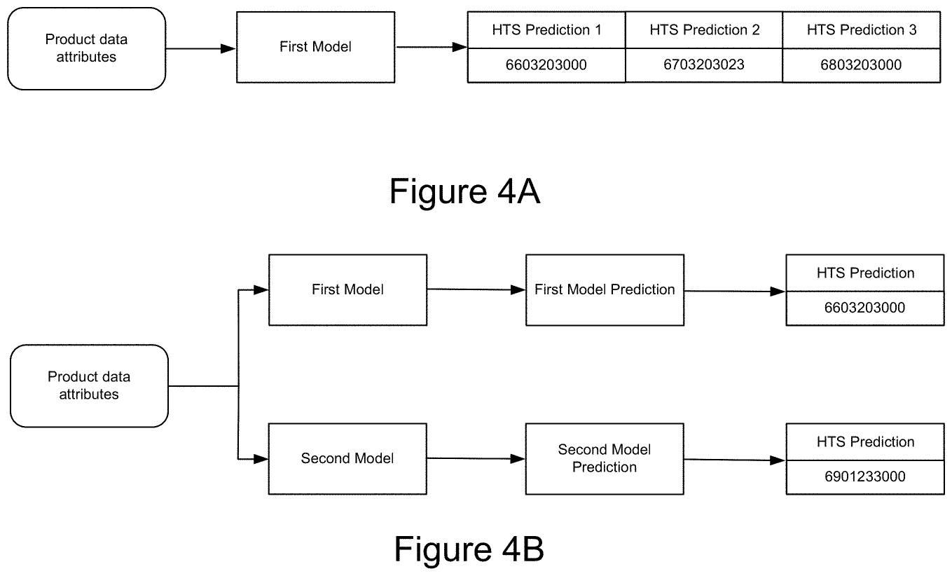

The multiple prediction engine 252 analyzes an input set of data attributes for a product using a machine learning model 226 and generates multiple predictions of standardized code and associated confidence scores for the same input set of data attributes. FIGS. 4A-4B show graphical representations illustrating example predictive frameworks for multiple prediction and multi-model prediction. In FIG. 4A, the graphical representation shows that the ‘First Model’ is input with a set of product data attributes. The ‘First Model’ may be a trained machine learning model for predicting HTS code classification of the product attributes and generates three predictions for HTS code. For example, the ‘HTS Prediction 1’ may have an 85% confidence score, the ‘HTS Prediction 2’ may have a 77% confidence score, and the ‘HTS Prediction 3’ may have a 10% confidence score. In some implementations, the multiple prediction engine 252 instructs the user interface engine 210 to generate a user interface of a worklist and populates the worklist with the multiple predictions for the product for user review. The user is provided with multiple predictions to select from and finalize the assignment of the standardized code for product classification. This user review may help to reduce the risk of erroneous product classification. The multiple prediction engine 252 may forward the feedback provided by the user in the review to the machine learning engine 204 for retraining the models 226.

The multi-model prediction engine 254 analyzes the same input set of data attributes for a product using multiple machine learning models 226 and generates individual predictions of standardized code and associated confidence score from each machine learning model 226. The multi-model prediction engine 254 analyzes the input set of data attributes for the product only once by passing them to the multiple machine learning models 226 simultaneously for prediction. This configuration increases the efficiency of the product classification system by reducing the duplicate effort of passing the same input set of data attributes multiple times. For example, the multi-model prediction engine 254 saves the input set of data attributes of the product in the memory 237 and passes the same to the different machine learning models 226 on-the-fly in a single request. This conserves computing resources, such as memory, processor, and networking resources. In FIG. 4B, the graphical representation shows the same input set of data attributes being input into two machine learning models in a single request. For example, a product may have a subset of data attributes shared between two countries, such as the USA and Canada. The ‘First Model’ may be a HTS predictive model for the USA and the ‘Second Model’ may be a HTS predictive model for Canada. Each model generates an independent prediction for HTS code classification for the product in the respective countries based on the same request. In some implementations, the prediction engine 206 may configure the multiple prediction engine 252 and the multi-model prediction engine 254 in a hybrid fashion to use multiple predictions with multi-model predictions. In some implementations, the multi-model prediction engine 254 implements majority voting and selects the prediction of a standardized code with the highest number of votes among the multiple models.

The re-classification engine 256 receives an existing or old standardized code for a product classification and converts it to a new standardized code. For example, the US customs authorities may publish a newer version of the harmonized tariff schedule and previously classified products may need to be updated. In some implementations, the re-classification engine 256 may create a lookup table mapping the old HTS codes to the newer HTS codes. The re-classification engine 256 may create a rule based model where the mapping rules are defined in a structured, one-to-one association between the old and the new standardized codes. The re-classification engine 256 may maintain and update the mapping rules based on one or more business requirements, user input, and updates from regulatory agencies with regard to the changes in the product classification or numbering scheme. The re-classification engine 256 may store these rule-based models in the data storage 243 and load them into the memory 208 for re-classification tasks.

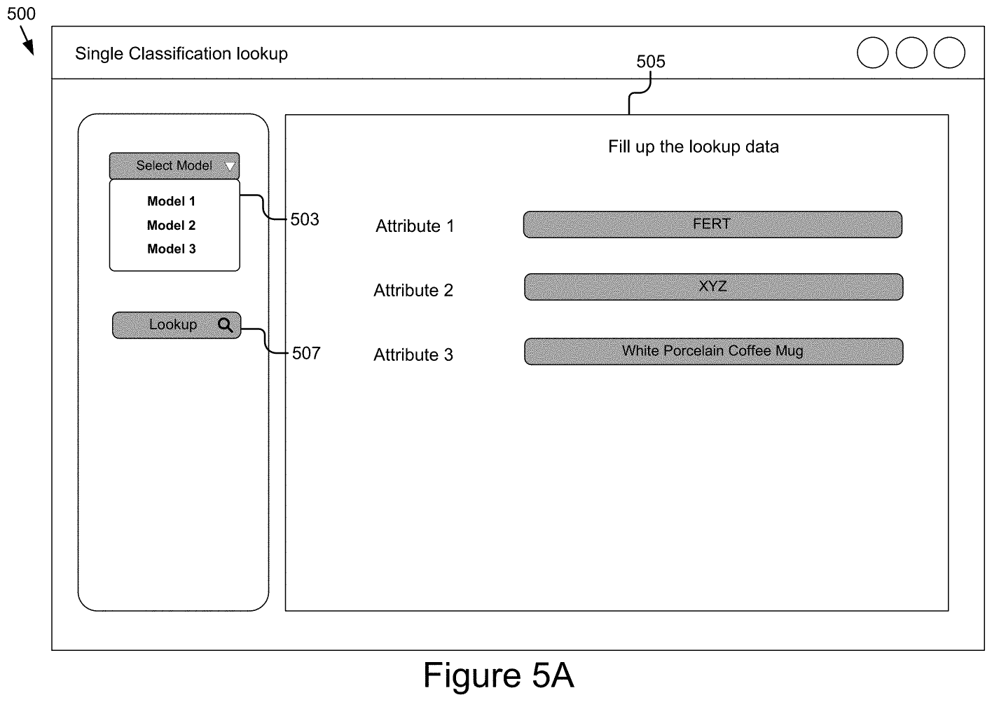

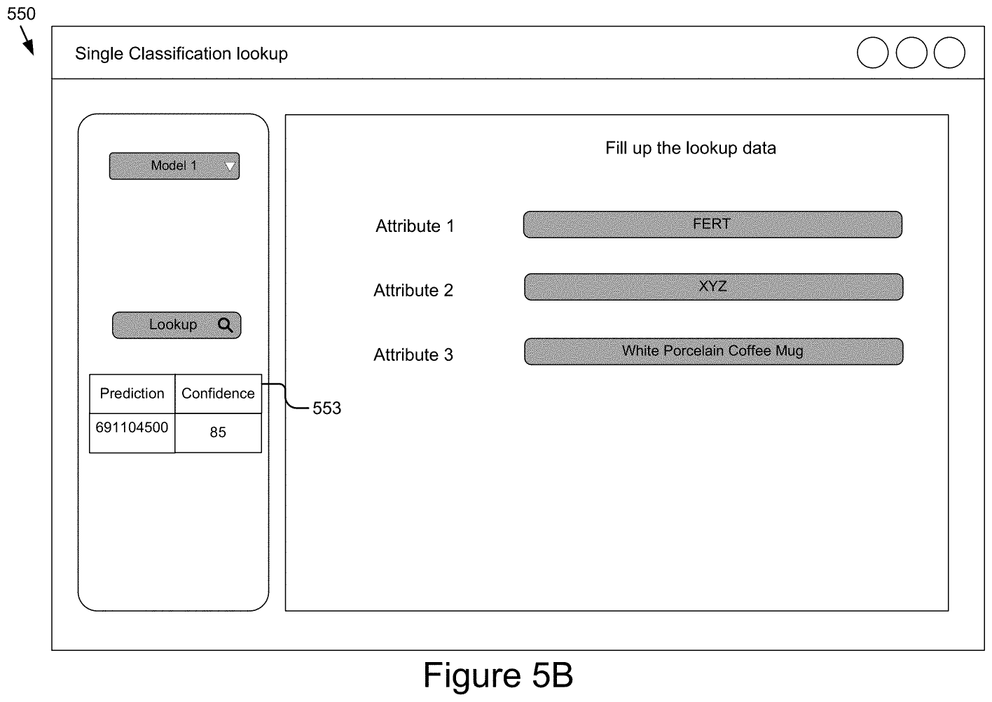

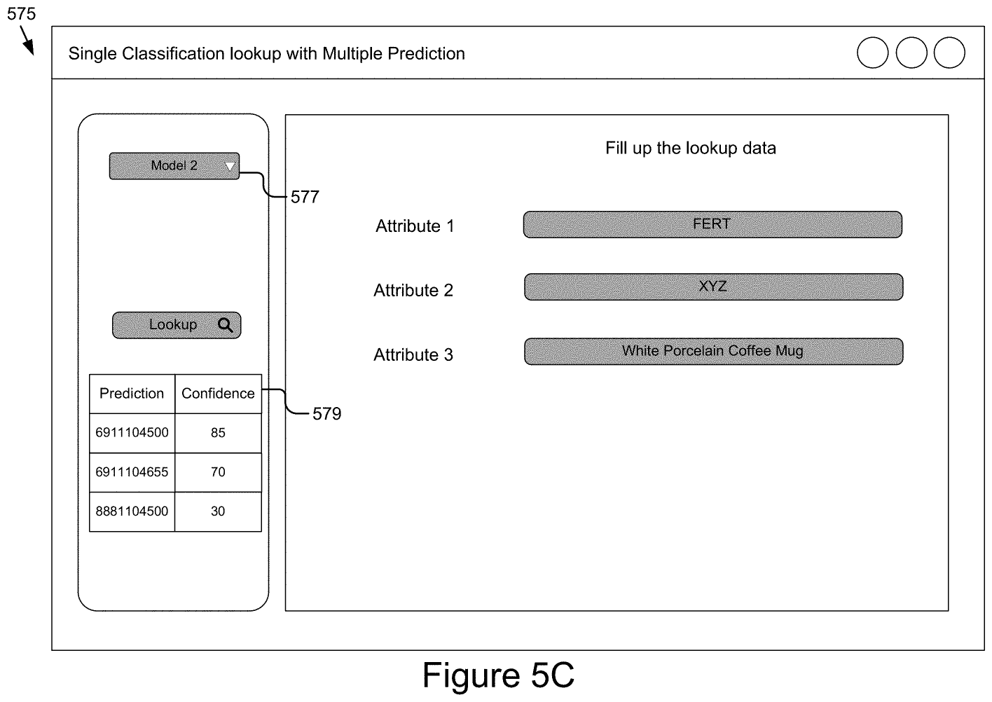

FIGS. 5A-5C show graphical representations illustrating example user interfaces for generating a prediction of product classification for a single product. The example user interfaces may be presented on a web browser on the client device 115. In FIG. 5A, the user interface 500 includes a model selection drop down menu 503 where a user may select a machine learning model ‘model 1’ to load for scoring predictions, a form 505 to fill up where the user inputs the product attributes in the given fields, and a lookup button 507 which the user may select to pass the product attributes to the selected model for generating a prediction of a standardized code for product classification. In FIG. 5B, the user interface 550 includes a table 553 showing the predicted result of the standardized code and a confidence score for the prediction in response to the user selecting the lookup button 507 in FIG. 5A. In FIG. 5C, the user interface 575 includes a table 577 showing multiple predictions of standardized code and associated confidence score sorted in a descending order based on the selection of ‘model 2’ by the user.

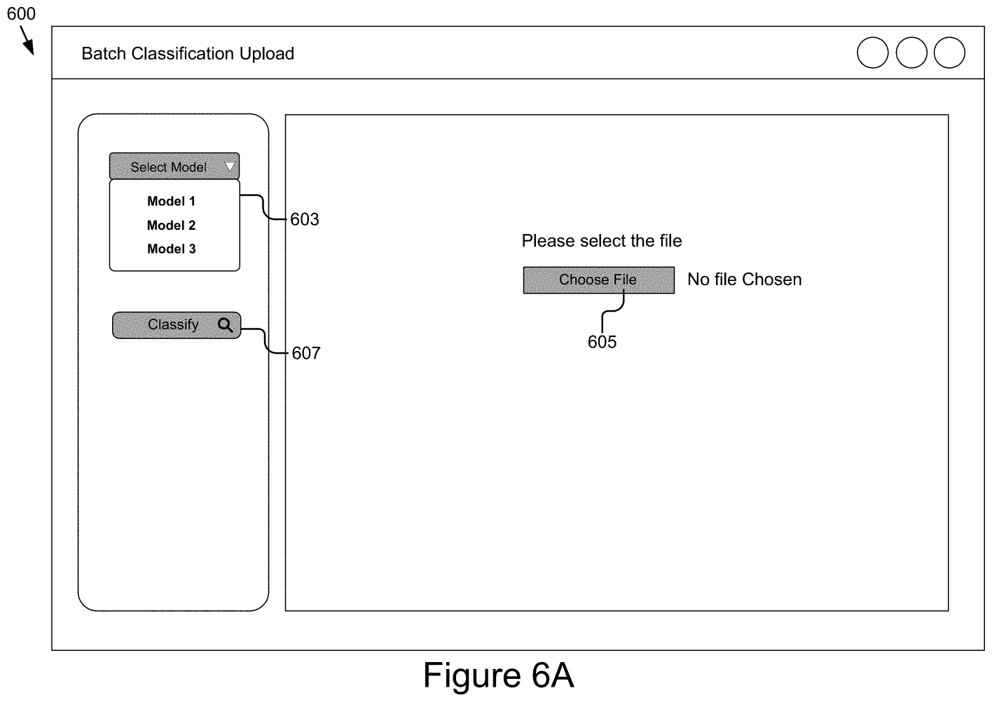

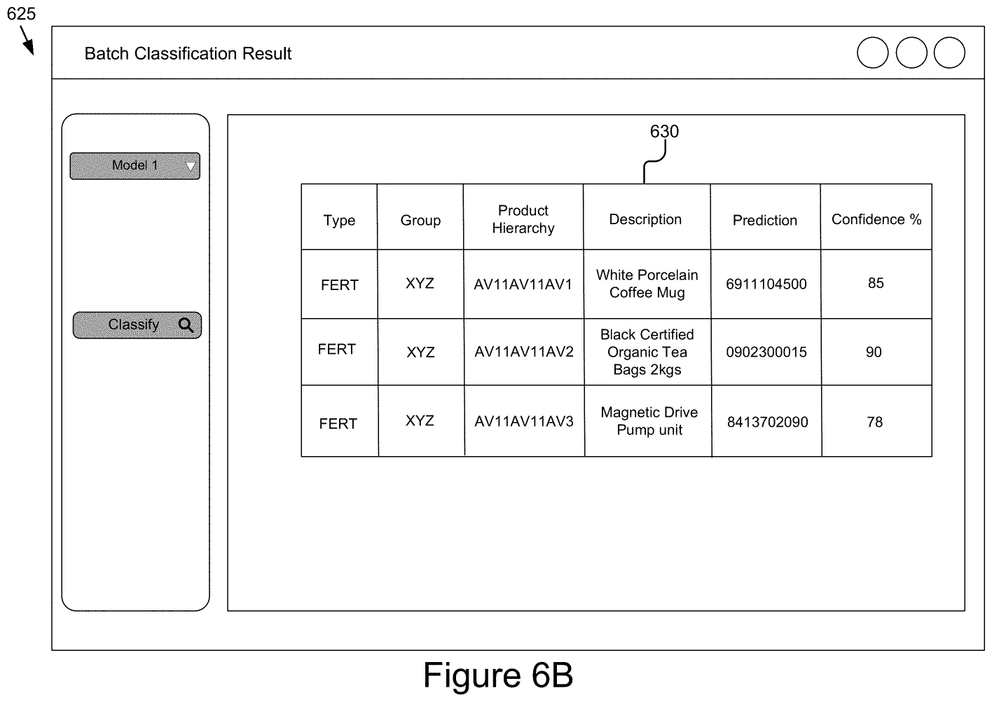

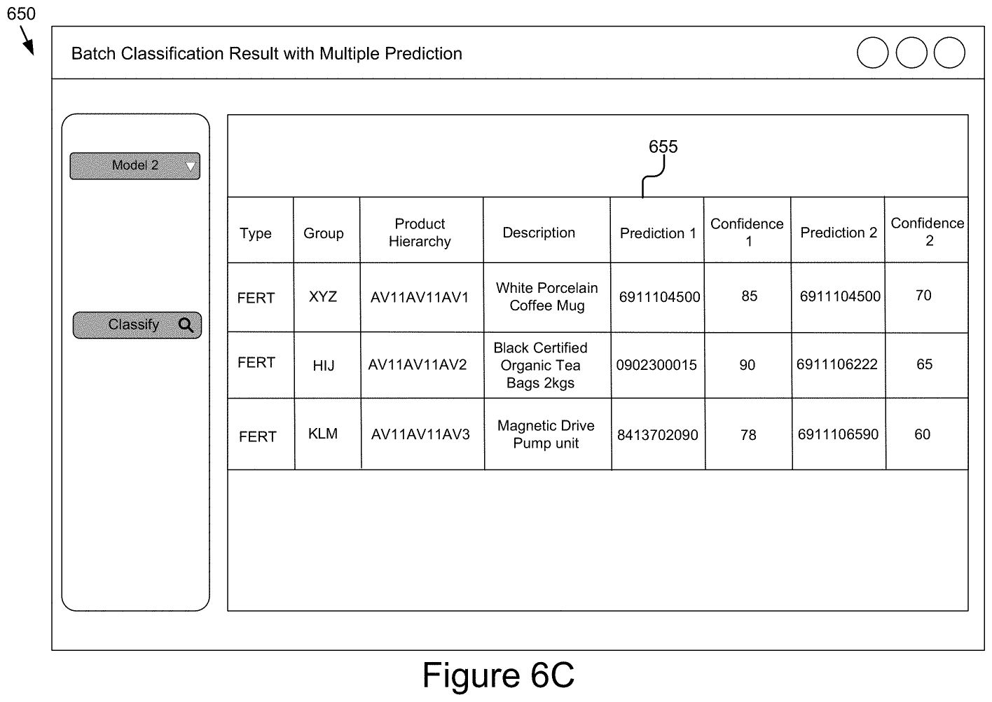

FIGS. 6A-6C show graphical representations illustrating example user interfaces for generating a prediction of product classification for a batch of products. In FIG. 6A, the user interface 600 includes a ‘Choose File’ button 605 which the user may select to upload a file containing a batch of products for batch prediction. For example, the file upload option may support file formats, such as a CSV file, a Microsoft® Excel file, etc. After the file is uploaded, the user may select a machine learning model ‘model 1’ in the drop down menu 603 and select the ‘Classify’ button 607 to obtain a result. In FIG. 6B, the user interface 625 includes a table 630 that shows the prediction result of standardized code and associated confidence score determined for each row of product data attributes. In FIG. 6C, the user interface 650 includes a table 655 showing multiple predictions of standardized code and associated confidence score for each row of product data attributes based on the selection of ‘model 2’ by the user. The multiple predictions and associated confidence scores are identified in different columns of the table 655.

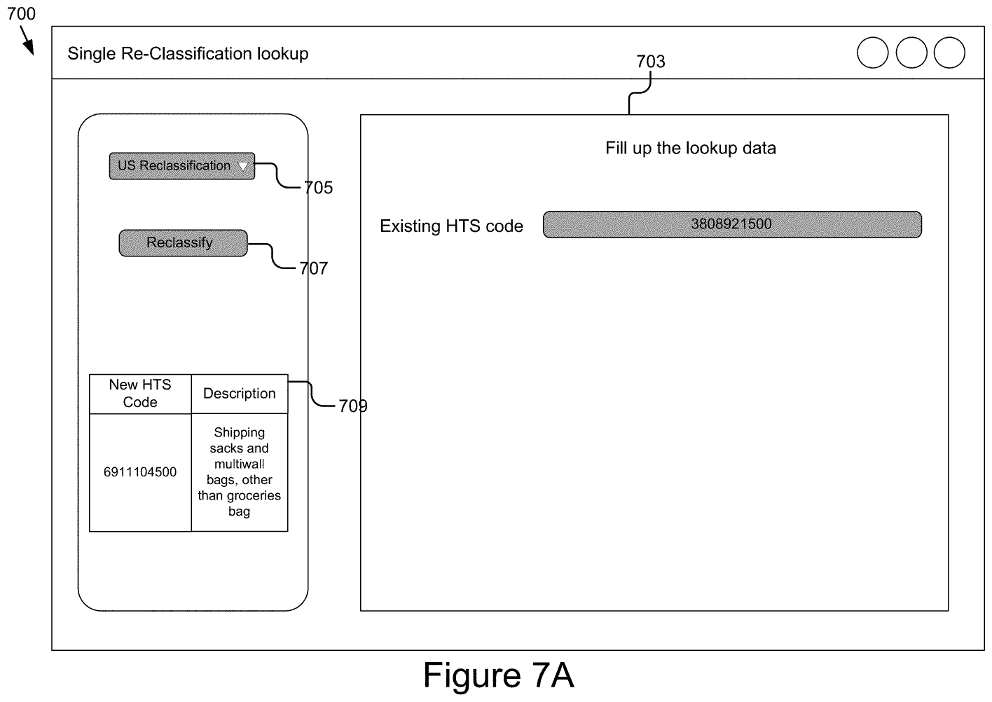

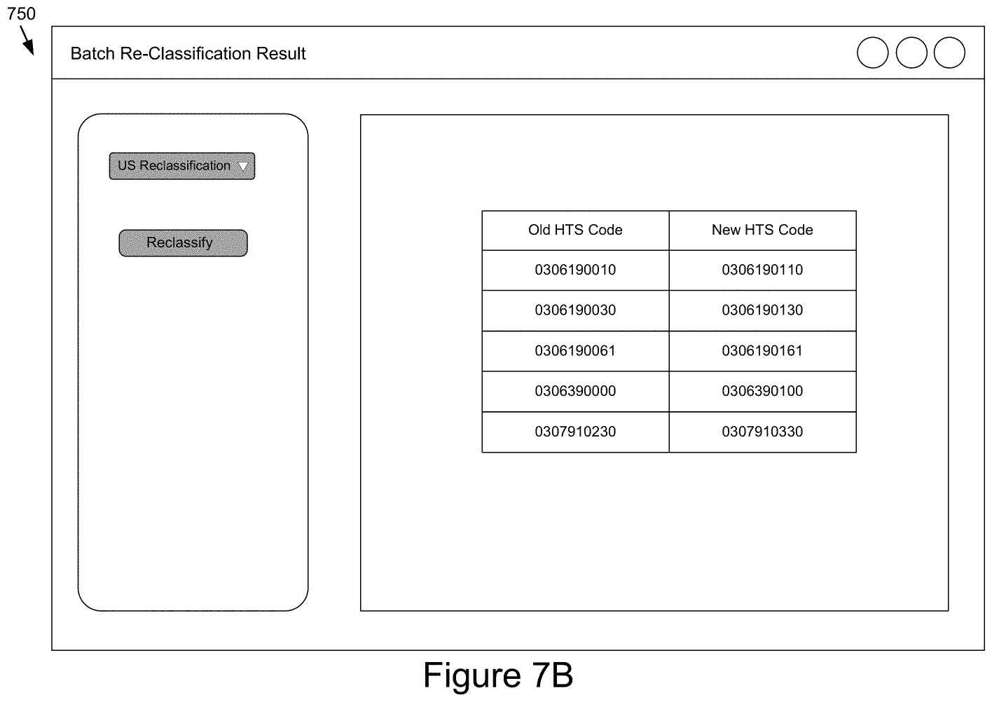

FIGS. 7A-7B show graphical representations illustrating example user interfaces for reclassifying old standardized codes of product classification. In FIG. 7A, the user interface 700 includes a form 703 for the user to enter an existing standardized code, such as HTS code for a product classification. When the user selects a re-classification model 705 in the drop down menu and selects the ‘reclassify’ button 707, the user interface 700 includes a table 709 showing the new HTS code for the product classification and a description of the new HTS code. In FIG. 7B, the user interface 750 displays the results of a batch re-classification in the table 753 with two columns—old HTS Code and new HTS Code. Old HTS Code is the input provided to the re-classification model and new HTS Code is the code that is generated from reclassification service.

The health check engine 258 may include software and/or logic to provide functionality for analyzing the effectiveness of machine learning models 226 used by the prediction engine 206 and optimizing them based on the analysis. In one example, the health check engine 258 is coupled to the data storage 243 to retrieve the classification results 228, analyze the status of classification results in terms of success, error, or failure, and evaluate the effectiveness of the machine learning models 226. The health check engine 258 is also capable of providing a secure portal to allow data scientists, analysts or engineering staff to analyze the models 226 by applying different example data inputs and reviewing the output. In one example, the health check engine 258 determines model effectiveness based on user's actions (e.g., accepting the prediction, rejecting the prediction, selecting a prediction with a lower confidence score, etc.) when presented with the predictions of the standardized codes for product classification. The health check engine 258 determines one or more metrics for evaluating the quality of operational machine learning models 226 used by the prediction engine 206. For example, the health check engine 258 determines several metrics including accuracy, precision, and recall of the output predicted by the operational models 226 based on the actions of the user. The health check engine 258 may also facilitate with refining of model training data, machine learning hints, scoring thresholds, etc. through the analytics process. The health check engine 258 sends data regarding the refinements to the machine learning engine 204 as input into retraining and updating models in an iterative process. In one example, the health check engine 258 triggers retraining of the models 226 when the average confidence score during predictions drops below a predetermined threshold, when new types of products falling under new product classifications (e.g., new standardized codes) are introduced, and when the government and regulatory agencies make changes to the product classification system (e.g., change standardized codes).

Referring back to FIG. 2A, the remaining components of the prediction application 110 will be described.

The action engine 208 may include software and/or logic to provide functionality for determining an actionable item based on the predicted standardized code in association with the classification of the product. For example, the actionable items may relate to facilitating with compliance and customs declaration activities in the context of global trade and transport management service. The action engine 208 receives the prediction of the standardized code and an associated confidence score for the prediction from the prediction engine 206. The action engine 208 determines whether the confidence score for a predicted standardized code satisfies a predetermined threshold for recommending one or more actionable items. For example, the action engine 208 recommends one or more actionable items in association with the identified product classification if the confidence score satisfies a threshold of 95%. In some implementations, the action engine 208 is coupled to receive one or more operational machine learning models 226 deployed by the machine learning engine 204. The action engine 208 uses a machine learning model to process the inputs, such as the prediction of the standardized code and associated confidence score, user profile data, contextual and analytical data associated with the input set of product attributes, etc. The action engine 208 determines a recommendation of an actionable item based on the output of the machine learning model. In some implementations, the action engine 208 may present the recommended actionable item in the worklist of the user. For example, the actionable item may prompt the user to record the prediction of the product classification into the product master data, to fill-up a compliance-related document using the prediction of product classification, to file for an export license using the prediction of product classification, to remove a blocked order using the prediction of product classification, to screen trade of the product to a customer (e.g., sanctioned party list screening) using the prediction of product classification, etc. The actionable item may include a user interface element (e.g., deep link) that links to a specific location or page associated with performing the action and initiates the action without any prompts, interstitial pages, or logins.

In some implementations, the action engine 208 may automatically execute the recommended actionable item if the confidence score of the predicted product classification satisfies a predetermined threshold. In one example, the action engine 208 determines that a compliance-related document, such as an export license is needed for a product based on a prediction of an export control classification number (ECCN) for the product satisfying a confidence score threshold. The action engine 208 identifies the application for an export license as the actionable item, prepopulates the application with the requisite product and shipment information in the worklist, displays the prepopulated application on the client device 115, and automatically submits the application to the appropriate government authority for approval. In another example, the action engine 208 determines import tariff (duty) rates for an imported product based on a prediction of a harmonized tariff schedule (HTS) code satisfying a confidence score threshold. The action engine 208 identifies the entry and release forms to submit as the actionable item, prepopulates the forms with the appropriate duty amount for the imported product based on the HTS code, and automatically submits the forms to the appropriate government authority. In another example, the action engine 208 identifies an import order blocked in the worklist for a product. The action engine 208 automatically populates the predicted HTS code for the product in the worklist and automatically triggers a compliance re-screening to remove the block.

The user interface engine 212 may include software and/or logic for providing user interfaces to a user. In some implementations, the user interface engine 212 receives instructions from the components 202, 204, 206, 208, and 210, generates a user interface according to the instructions, and transmits the user interface for display on the client device 115 as described below with reference to FIGS. 5A-5C, 6A-6C, and 7A-7B. In some implementations, the user interface engine 212 sends graphical user interface data to an application (e.g., a browser) in the client device 115 via the communication unit 241 causing the application to display the data as a graphical user interface.

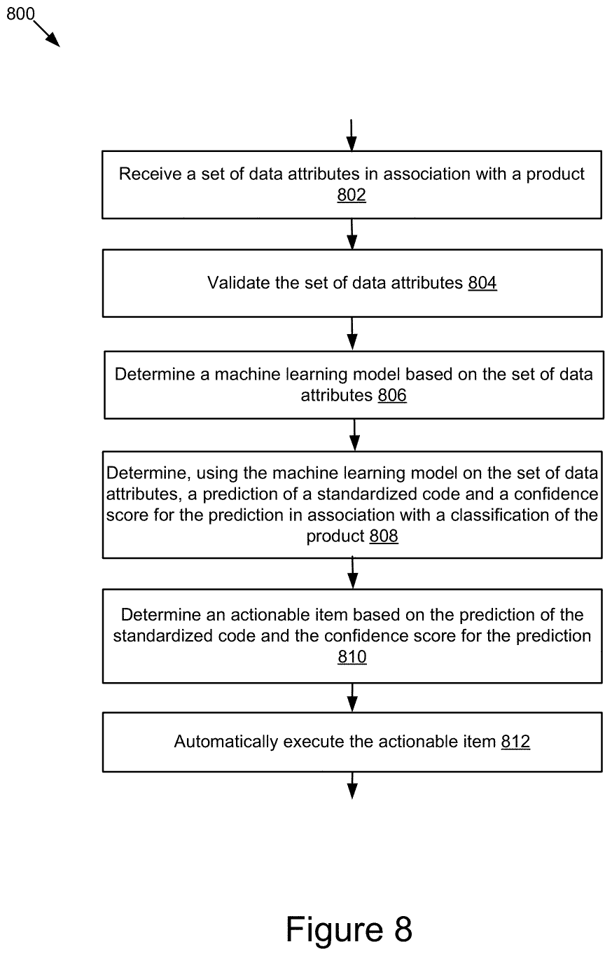

FIG. 8 is a flow diagram of an example method 800 for predicting a standardized code classifying a product and automatically executing an actionable item based on the standardized code. At 802, the prediction engine 206 receives a set of data attributes in association with a product. At 804, the prediction engine 206 validates the set of data attributes. At 806, the prediction engine 206 determines a machine learning model based on the set of data attributes. At 808, the prediction engine 206 determines a prediction of a standardized code and a confidence score for the prediction in association with a classification of the product using the machine learning model on the set of data attributes. At 810, the action engine 208 determines an actionable item based on the prediction of the standardized code and the confidence score for the prediction. At 812, the action engine 208 automatically executes the actionable item.

A system and method for predicting a standardized code classifying a product and automatically executing an actionable item based on the standardized code has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one implementation above primarily with reference to software and particular hardware. However, the present invention applies to any type of computing system that can receive data and commands, and present information as part of any peripheral devices providing services.

Reference in the specification to “one implementation” or “an implementation” means that a particular feature, structure, or characteristic described in connection with the implementation is included in at least one implementation. The appearances of the phrase “in one implementation” in various places in the specification are not necessarily all referring to the same implementation.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), Web Socket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies, engines, and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
receiving a set of data attributes in association with a product;
validating the set of data attributes;
determining a first machine learning model based on the set of data attributes;
determining, using the first machine learning model on the set of data attributes, a first prediction of a standardized code and a first confidence score for the first prediction in association with a classification of the product;
determining whether the first confidence score satisfies a threshold;
responsive to determining that the first confidence score satisfies the threshold, determining an actionable item based on the standardized code in association with the classification of the product; and
automatically executing the actionable item.

2. The computer-implemented method of claim 1, further comprising:
responsive to determining that the first confidence score fails to satisfy the threshold, presenting, for display in a worklist, the first prediction of the standardized code and the first confidence score for the first prediction;
receiving, from a user associated with the worklist, feedback in association with the first prediction of the standardized code and the first confidence score for the first prediction; and
assigning the first prediction of the standardized code to the classification of the product based on the feedback.

3. The computer-implemented method of claim 1, further comprising:
determining, using the first machine learning model on the set of data attributes, a second prediction of the standardized code and a second confidence score for the second prediction in association with the classification of the product;
presenting, for display in a worklist, the first prediction of the standardized code and the first confidence score for the first prediction and the second prediction of the standardized code and the second confidence score for the second prediction; and
wherein one of the first confidence score and the second confidence score is higher than the other.

4. The computer-implemented method of claim 1, further comprising:
determining a second machine learning model based on the set of data attributes; and
determining, using the second machine learning model on the set of data attributes, a third prediction of a standardized code and a third confidence score for the third prediction in association with the classification of the product.

5. The computer-implemented method of claim 1, wherein determining the first machine learning model further comprises:
determining a context in association with the set of data attributes;
matching the context with a set of metadata associated with the first machine learning model; and
selecting the first machine learning model based on the matching.

6. The computer-implemented method of claim 1, wherein determining the first machine learning model further comprises:
receiving a unique identifier of a machine learning model in association with the set of data attributes; and
selecting the first machine learning model from a plurality of machine learning models based on the unique identifier.

7. The computer-implemented method of claim 2, further comprising:
updating a training dataset based on the feedback; and
training the first machine learning model using the updated training dataset.

8. The computer-implemented method of claim 1, wherein the set of data attributes in association with the product is a row in a table of products.

9. The computer-implemented method of claim 1, wherein the set of data attributes in association with the product is received from a group of a business management server, a client device, and an external database.

10. The computer-implemented method of claim 1, wherein the actionable item is associated with compliance and customs declaration.

11. A system comprising:
one or more processors; and
a memory, the memory storing instructions, which when executed cause the one or more processors to:
receive a set of data attributes in association with a product;
validate the set of data attributes;
determine a first machine learning model based on the set of data attributes;
determine, using the first machine learning model on the set of data attributes, a first prediction of a standardized code and a first confidence score for the first prediction in association with a classification of the product;
determine whether the first confidence score satisfies a threshold;
responsive to determining that the first confidence score satisfies the threshold, determine an actionable item based on the standardized code in association with the classification of the product; and
automatically execute the actionable item.

12. The system of claim 11, wherein the instructions further cause the one or more processors to:
responsive to determining that the first confidence score fails to satisfy the threshold, present, for display in a worklist, the first prediction of the standardized code and the first confidence score for the first prediction;
receive, from a user associated with the worklist, feedback in association with the first prediction of the standardized code and the first confidence score for the first prediction; and
assign the first prediction of the standardized code to the classification of the product based on the feedback.

13. The system of claim 11, wherein the instructions further cause the one or more processors to:
determine, using the first machine learning model on the set of data attributes, a second prediction of the standardized code and a second confidence score for the second prediction in association with the classification of the product;
present, for display in a worklist, the first prediction of the standardized code and the first confidence score for the first prediction and the second prediction of the standardized code and the second confidence score for the second prediction; and
wherein one of the first confidence score and the second confidence score is higher than the other.

14. The system of claim 11, wherein the instructions further cause the one or more processors to:
determine a second machine learning model based on the set of data attributes; and
determine, using the second machine learning model on the set of data attributes, a third prediction of a standardized code and a third confidence score for the third prediction in association with the classification of the product.

15. The system of claim 11, wherein to determine the first machine learning model, the instructions further cause the one or more processors to:
determine a context in association with the set of data attributes;
match the context with a set of metadata associated with the first machine learning model; and
select the first machine learning model based on the matching.

16. The system of claim 11, wherein to determine the first machine learning model, the instructions further cause the one or more processors to:
receive a unique identifier of a machine learning model in association with the set of data attributes; and
select the first machine learning model from a plurality of machine learning models based on the unique identifier.

17. The system of claim 12, wherein the instructions further cause the one or more processors to:
update a training dataset based on the feedback; and
train the first machine learning model using the updated training dataset.

18. The system of claim 11, wherein the set of data attributes in association with the product is a row in a table of products.

19. The system of claim 11, wherein the set of data attributes in association with the product is received from a group of a business management server, a client device, and an external database.

20. The system of claim 11, wherein the actionable item is associated with compliance and customs declaration.
